(19) United States
(12) Patent Application Publication
(10) Pub. No.: US 2017/0286140 A1
(43) Pub. Date: Oct. 5, 2017

(54) JAVA-BASED OFFLOAD SERVICE IN A MAINFRAME ENVIRONMENT

(71) Applicant: CA, Inc., New York, NY (US)

(72) Inventors: Janet Pauline Eva Lowry, Addison, IL (US); Frederic Armand Honore Duminy, St. Charles, IL (US); Howard Israel Nayberg, Plainview, NY (US); Christopher Jamie Varughese, Morton Grove, IL (US)

(21) Appl. No.: 15/087,924

(22) Filed: Mar. 31, 2016

(51) Int. Cl. G06F 9/455; G06F 9/54

(52) U.S. Cl. CPC G06F 9/45504; G06F 9/541

(57) ABSTRACT

A JVM can be used as a conduit for transferring work items and results for work items between different processes/processors for a mainframe environment. The JVM provides infrastructure that allows a Java program running within the JVM to invoke native methods (e.g., assembly code methods) with a Java Native Interface (JNI). The Java program invokes a native method with the JNI to begin monitoring for work items and passes detected work items for processing to an appropriate resource, which was likely previously established. To pass a work item to a Java program, a native program code invokes Java code via the JNI that inserts a work item into the JVM address space (e.g., put the work item into a byte buffer). When the Java program obtains a work item result, the Java program invokes the native method via the JNI that writes a work item result to common storage.

### BACKGROUND

The disclosure generally relates to the field of data processing, and more particularly to cross communication between address spaces.

Mainframe operating systems typically use address spaces as a structuring tool to help in isolating failures and to provide for reliability, stability, availability, and security. An address space is a range of virtual addresses that an operating system assigns to a user or program for executing instructions and storing data. The range of virtual addresses maps to physical memory, either directly or via another level of indirection. Mainframe operating systems also manage mapping of virtual addresses to a common storage of the mainframe. A mainframe uses common storage to allow processes to transfer data instantiated as objects in common storage to minimize copying overhead. Instead of copying an object, a process passes control of the object in common storage to another process. Control of the object is passed by changing ownership of the memory area or passing control of a reference to the memory area. If ownership is changed, the operating system notifies the new owning process of the change of ownership. If control is passed by passing control of the reference to the memory area, the reference is passed through the operating system.

Common storage can be read by both authorized and unauthorized programs. Authorized programs can obtain and release common storage. A process is authorized if it runs in supervisor state, or if authorized by the Authorized Program Facility (APF).

### BRIEF DESCRIPTION OF THE DRAWINGS

Embodiments of the disclosure may be better understood by referencing the accompanying drawings.

FIG. 1 depicts a conceptual example of a cross-address space work item offload through a JVM.

FIG. 2 depicts a flow diagram of example operations for offloading work items with a Java process in a mainframe environment.

FIG. 3 depicts a flow diagram with example operations for processing and returning a result of a processed work item by a Java-based offload service in a mainframe environment.

FIG. 4 depicts an example mainframe system with a Java-based offload service.

### DESCRIPTION

The description that follows includes example systems, methods, techniques, and program flows that embody embodiments of the disclosure. However, it is understood that this disclosure may be practiced without these specific details. For instance, this disclosure refers to cross-address space communications with a Java process in a Java Virtual Machine (JVM) residing in an address space in the illustrative examples. But aspects of this disclosure can be applied to cross-address space communications with any application or process in a virtual machine (e.g. common language runtime) residing in an address space. Aspects of this disclosure can also be applied to other programming frameworks that enable a process inside a virtual machine to communicate with other program/platform dependent languages such as the Raw Native Interface (“RNI”). In other instances, well-known instruction instances, protocols, structures and techniques have not been shown in detail in order not to obfuscate the description.

Introduction

The cost of processing data with a mainframe can be expensive. Although a computing job (i.e., a coherent group of computing tasks) may rely on capabilities of a mainframe or at least use programs already hosted on a mainframe, some tasks of the computing job can be offloaded for processing with less costly resources and/or more specialized resources. For example, a security type of computing job can offload cryptographic computations from the mainframe to a trusted, resource (e.g. Rivest-Shamir-Adleman cryptosystem (RSA®) server). Offloading a computing task can involve transfer of data and/or program code (hereinafter “work item”) from an address space of a requesting process on the mainframe to an address space corresponding to the trusted resource while still leveraging capabilities of the mainframe, such as concurrent processing of transactions on a large scale (e.g., hundreds of thousands of transactions per second).

Overview

A JVM can be used as a conduit for transferring work items and results for work items between different processes/processors for a mainframe environment. The JVM provides infrastructure that allows a Java program running within the JVM to invoke native program code (e.g., assembly code) with a Java Native Interface (JNI). The Java program invokes native program code with the JNI to begin monitoring for work items and passes work items provided by the invoked native program code to a resource for processing. To pass a work item to a Java program, the native program code invokes, via the JNI, Java program code that inserts a work item into the address space in which the JVM resides (e.g., put the work item into a buffer defined by the JVM or Java program). When the Java program obtains a work item result, the Java program invokes the native program code via the JNI, and the invoked native program code writes the work item result to common storage.

Example Illustrations

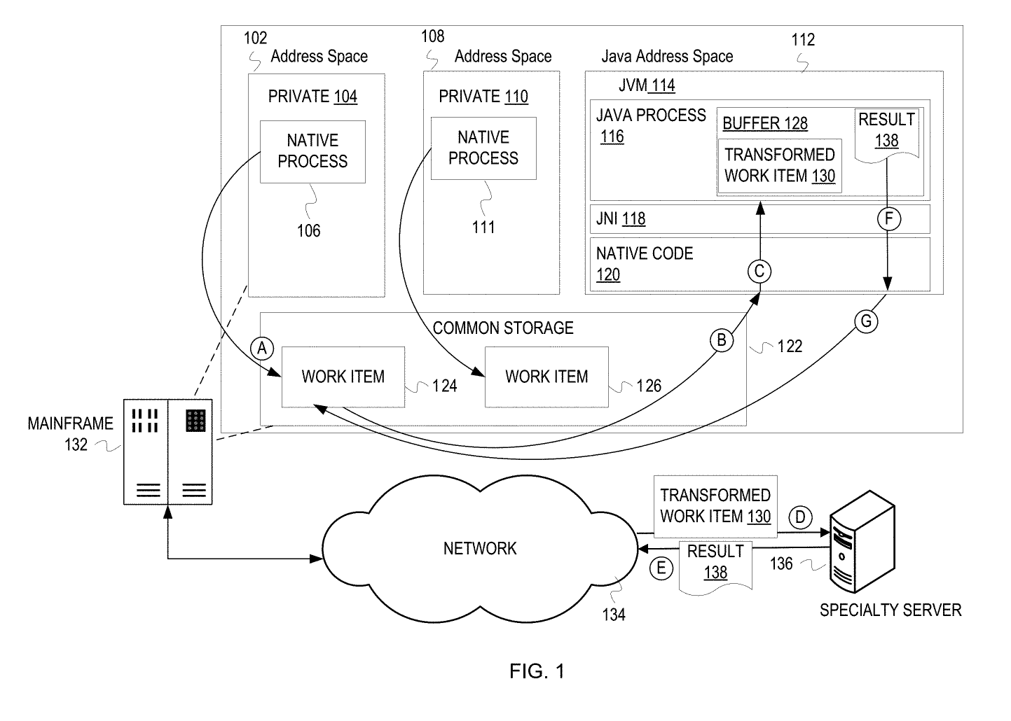

FIG. 1 depicts a conceptual example of a cross-address space work item offload through a JVM. FIG. 1 includes a mainframe 132 in communication with specialty server 136 via a network 134. The specialty server 136 is an example external resource that can perform a task(s) offloaded from the mainframe 132. The mainframe 132 and the specialty server 136 have already established trust between each other. The mainframe 132 includes common storage 122. A JVM 114 is running on the mainframe 132. The JVM 114 encapsulates a JNI 118 and native program code (“native code”) 120. The JNI 118 can be considered to encapsulate the native code 120 in some cases. The mainframe 132 has assigned the JVM 114 an address space 112 (hereinafter “Java address space”). The mainframe has assigned an address space 102 to a native process 106 to perform a computing job, and assigned a native process 111 an address space 108. The address space 102 includes a private area 104 where program code of the native process 106 resides and in which the process 106 operates. The address space 108 includes a private area 110 where program code of the process 111 resides and in which the process 111 operates.

FIG. 1 lists a series of letters A-G. These letters represent operational stages, each of which may include multiple operations. Although these stages are ordered for this example, the stages illustrate one example to aid in understanding this disclosure and should not be used to limit the claims. Subject matter falling within the scope of the claims can vary with respect to the order and some of the operations.

FIG. 1 depicts the JVM 114 as hosting a Java process 116. This Java process 116 offloads tasks through the Java address space 112. Offloading through the Java address space 112 can be considered synonymous with offloading through the JVM 114. The Java process 116 offloads by calling native methods as exposed by the JNI 118 and defined in the native code 120. When the Java process 116 starts within the JVM 114, the Java process 116 initializes infrastructure of the mainframe 132 for cross address space offloading of work items. The Java process 116 registers with the operating system of the mainframe 132. This registration includes creating an anchor in the common storage 122 (e.g., a storage anchor block). This anchor in common storage is a root for work items placed into the common storage 122 for offloading through the JVM 114. The location of the anchor is available for discovery by other processes of the mainframe 132 for offloading of work items. This registration process may also include establishing a contract or specification that defines a format or arrangement of a work item placed into the common storage 122. In addition, the Java process 116 obtains authority and/or privileges sufficient for invoked native methods to access the common storage 122. The Java process 116 carries out this registration with calls to native methods in the native code 120 via the JNI 118.

After establishing the anchor in common storage 122 for work items and work item results, the Java process 116 invokes a native method of the native code 120 to begin monitoring for work item requests in the common storage 122. The Java process 116 invokes the native method through the JNI 118. The invoked native method, for example, can be a Multiple Virtual Storage (MVS) WAIT macro.

At stage A, native process 106 stores a work item 124 into the common storage 122. As stated earlier, the work item 124 can be data to be processed or program code to be executed. The operating system of the mainframe 132 may place constraints (e.g., to conform to execution privileges) on what can be written into the common storage 122 and/or where it can be written into the common storage 122.

At stage B, the native process 106 causes a notification to be generated that allows the Java process 116 to retrieve the work item 124 and that identifies the source of the work item 124 (native process 106). To generate the notification, the native process 106 can issue an MVS POST (“POST”). The POST macro is used to notify processes about the completion of an event, which in this case is storing of the work item 124 at the anchor in common storage 122 created by the Java process 116 with the native code 120. Issuance of the POST causes the native method previously invoked by the Java process to “wake up” (i.e., continue execution) and read the work item 124 from the common storage 122. For instance, an MVS dispatcher (“system dispatcher”) can update an event control block (ECB) to reflect the write of the work item 124 into the common storage 122. This ECB update causes the native method of the native code 120 to resume execution.

At stage C, the Java process 116 obtains access to the work item 124 from the resumed execution of native code 120 causing the work item 124 to be written into a buffer 128 of the JVM 114, after possible transformation. The native code 120 includes native code that transforms the work item 124 according to a specification that identifies data type conversions and format encodings for data moving between Java methods and native methods. The native code 120 transforms the work item 124 into a form that can be consumed by the Java process 116 and writes a transformed work item 130 into the buffer 128 (e.g., a char buffer). In addition to the transformed work item 130, the executing native code 120 also passes a value (e.g., common storage address of the work item) that facilitates return of a result for the work item to the native process 106. This value (“return identifier”) can be associated with the work item 124 and/or transformed work item 130. Passing of the work item 124 may include passing of the return identifier if the return identifier is embedded within the work item 124, for example as metadata or a field within the work item 124. If not embedded, the return identifier may be communicated via transfer control information read by the executing native code 120 from transfer control structures of the mainframe 132. The return identifier for the work item 124 may be the address within the common storage of the work item 124 and/or an identifier of the native process 106.

At stage D, the Java process 116 offloads the transformed work item 130 to the specialty server 126. The specialty server 126 may be a server configured to perform a specific function (e.g. RSA server, a processor designated for a Java execution environment, Integrated Facility for Linux (“IFL”), Internal Coupling Facility (“ICF”), etc.). A request-response paradigm may be used to exchange information between the Java process 116 to a server in a distributed computing environment. The request-response paradigm exchanges information through passing of messages between entities.

At stage E, the specialty server 136 finishes processing and/or performing the work item 130 and sends a response containing the result 138 to the Java process 116. The result 138 may be an object or any other format (e.g. string, bit flag, etc.) or combination thereof returned by a process in the specialty server 136. In some scenarios, a response may contain further instructions, or a status (e.g. OK, completed) and/or any other information (e.g. reason for status).

At stage F, the Java process 116 invokes another native method of the native code 120 via the JNI 118 to pass the work item result 138 back to the native process 106. The Java process 116 invokes a PUT-type method, for example, defined by the JNI 118 with Java program code compatible semantics. The code implementation underlying the PUT-type method reads the result 138 from the buffer 128 and transforms the work item result 138 into a form (e.g., format and/or encoding) compatible with the native process 106. In addition to the work item result 138, the Java process 116 also passes back the return identifier associated with the work item 124.

At stage G, the invoked native method of the native code 120 updates the work item 124 with the (transformed) result 138. The invoked native method of the native code 120 locates the work item 124 with the return identifier. The invoked native method of the native code 120 includes a POST macro which causes update of work item 124 with the result 138. The invoked native method of the native code 120 updates the work item 124 as specified by the native process 106. For instance, the native process 106 could have created the work item 124 arranged in a manner to accommodate the result 138 (e.g., created an object larger than the data to be processed or with a field(s) reserved for the result). The POST causes the result to be written at a particular location within the work item 124. This particular location was communicated in the transfer of control of the work item 124.

The native process 110 placed a work item 126 into the common storage 122 after the native process 106 placed the work item 124 into the common storage. After the invoked native code 120 implementation of the PUT-type method completes for the result of the work item 124, the Java process 116 can invoke the GET-type method again to invoke the underlying native code 120 to retrieve the work item 126 for the offloading service.

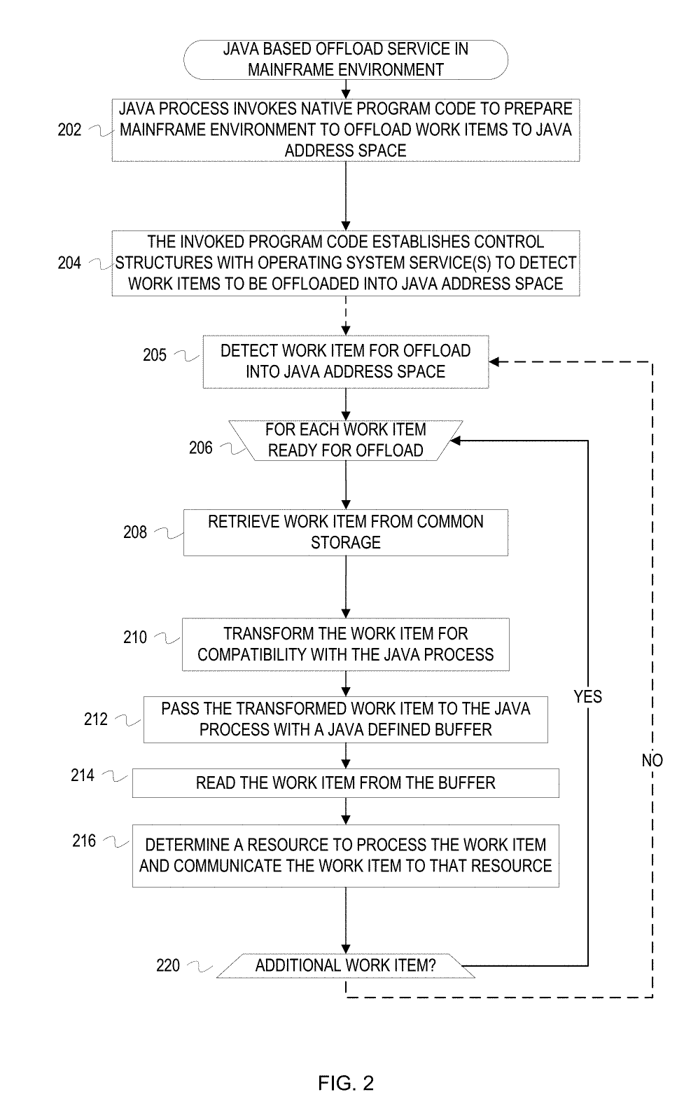

FIG. 2 depicts a flow diagram of example operations for offloading work items with a Java process in a mainframe environment. FIG. 2 refers to a Java-based offload service running in a mainframe environment as performing the example operations. The term “mainframe environment” is used to collectively refer to an operating system of a mainframe and associated hardware components. FIG. 2 uses dashed lines to depict asynchronous flow. For example, a waiting state or a transition state corresponding to an asynchronous request-response exchange.

A Java process invokes native code to prepare the mainframe environment to offload work items to the Java-based offload service in the Java address space (202). The Java process invokes native program code through a JNI to establish information and structures in the mainframe environment for detecting the posting of work items for offloading by the Java-based offload service (204). Establishing the information and structures can be considered a registration process carried out with defined operating system (OS) calls, which cause a service of the OS to notify the Java-based offloading service of posted work items. For example, a Java program for the Java-based offload service can be written with a Java method named “Start” that maps to native program code that implements the Start Java method with native methods defined for the mainframe environment. After the invoked native methods implementing the Java Start complete, the Java process is notified via the JNI that the Java-based offload service, or Java address space, is ready for offloading of work items from other address spaces. The Java process then invokes a Java defined Get that the JNI maps to native methods that include a GET and WAIT. The native program code will invoke the GET method to read structured data (e.g., a record) from a specified location, in this case a location in common storage allocated for work items. The native program code will also invoke the WAIT method since work items may not yet be posted to the location in common storage. Prior to the GET and WAIT, the native implementation of the Java Start method will establish an anchor in the common storage. The anchor can be considered a front of a queue or list to host work items to be retrieved by the Java-based offload service. Creation of this anchor involves the native program code making OS defined calls that initialize an area of the common storage to associate it with the Java-based offload service (e.g., create a task storage anchor block) and create a control block that allows a requesting process to pass control of a posted work item to the offload service and/or causes an OS service to resume execution of the native program code (“wake-up” the native program code). When multiple work items are pending in the list, the list can be traversed starting at the anchor to retrieve the pending work items.

The Java-based offload service detects posting of a work item for offload into the Java address space with the established information and structures (205). When a work item is posted into the common storage area associated with the offload service, the OS service wakes-up the native program code of the offload service. The OS service may update a control block associated with the offload service. The OS service may update the control block with information that identifies the work item (e.g., by address within common storage) and/or a process that generated the work item (e.g., by process identifier). Since multiple work items may have been posted while the offload service was in a wait state or while the offload service processes another work item, the native program code of the offload service may traverse the common storage area from the anchor to process each work item ready for offload (206). The native program code of the offload service may use an ECBLIST to monitor for posted work items. Each event control block (ECB) in the ECBLIST can represent a pending work item. When the native program code retrieves a work item, the native program code decrements the ECBLIST counter. The native program code of the offload service will continue retrieving work items represented by the ECBs until the ECBLIST counter reaches 0.

Upon detection of a pending work item, the native program code (executing native program code) retrieves the detected work item from common storage (208). The native program code can also retrieve other information to later associate a result with a work item and return the result. To “retrieve” the work item, the native program code copies the work item into the Java address space, which is the address space assigned to the Java-based offload service by the mainframe environment. This retrieval into the Java address space allows the Java process to obtain and process the work item. However, the Java process may not be capable of processing the work item without transformation into an encoding and/or format compatible with the Java process. Therefore, the native program code transforms the work item to be compatible with the Java process (210).

After transformation of the work item, the native program code passes the transformed work item to the Java process with a Java defined buffer (e.g., char buffer) (212). To “pass” the transformed work item, the native program code invokes a native method that maps to a Java method that notifies the Java process of a pending item in the buffer. The JNI may rearrange arguments of the native method to conform to semantics of the Java method. The arguments can include a memory address that corresponds to the Java buffer. The JNI may define the earlier GET method to establish a memory address that corresponds to the Java buffer for the retrieval. From the perspective of the native program code, the transformed work item is copied (208) to an address without any awareness of it supporting a Java buffer. The address has previously been associated with the Java buffer by the JVM.

Once notified of the work item in the Java buffer, the Java process reads the work item from the buffer (214). This moves the work item from the buffer into heap memory in which the Java process operates. The Java process then determines a resource to process the work item and communicates the work item to that resource (216). The resource may be a specified processor of the mainframe, an external resource (e.g., server), another Java process within the JVM, etc. The resource can be specified in the work item or can be established in advance with the Java process. For instance, a non-Java process can establish in advance that any work item from that process is to go to a specified resource. If defined in the work item, the Java process could examine a header or metadata of the work item to determine the offload target if the work item conforms to a defined structure previously identified to the Java process. However, work items can resolve to resources by privilege level associated with an originator of the work item and/or by type/category of the work item either defined in the work item or determined by the Java process. For instance, the Java process can offload encryption type of work items to a particular encryption processor/service depending up the originator. The Java process can also load balance work items across resources specified for a type of work item.

If there is an additional transformed work item in the buffer (220), then the Java process will process the next work item (206). The native program code will continue monitoring and retrieving posted work items.

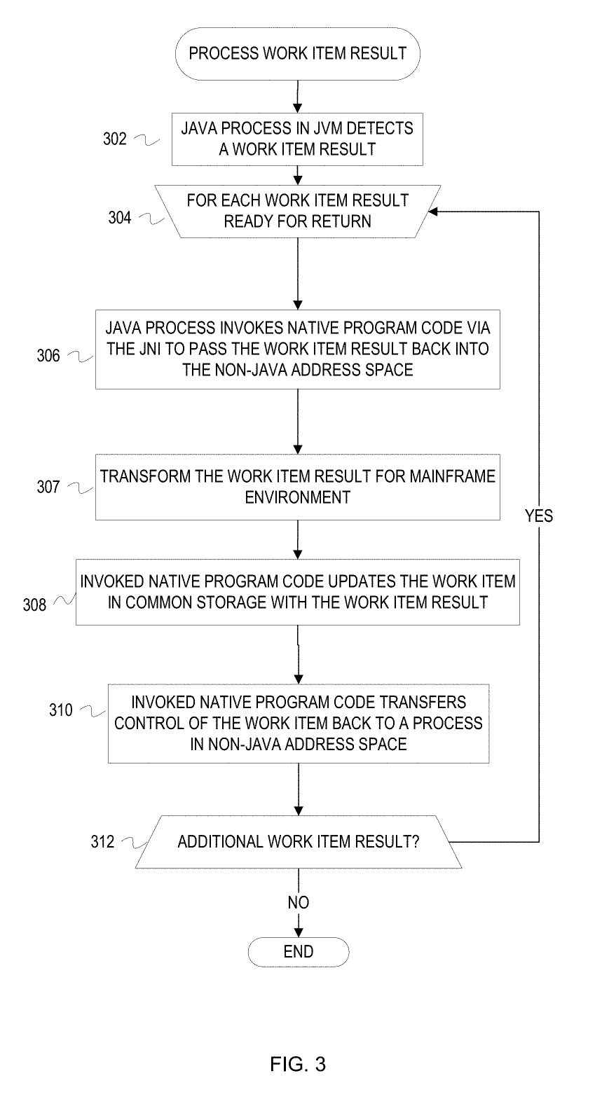

FIG. 3 depicts a flow diagram with example operations for processing and returning a result of a processed work item by a Java-based offload service in a mainframe environment. Previously, the offload service has communicated work items to one or more resources for processing, either external to the mainframe or specific resources of the mainframe.

A Java process in a JVM in a mainframe environment detects a work item result (302). The Java process can monitor a buffer or queue for responses from offload resources (“result buffer”). Detection of a work item results can be triggered based on receipt of a message according to a network communication protocol. The Java process may keep track of the work items by assigning a unique Job Identifier with each work item the Java process offloads. If a response is not received within a specific time period, the Java process may resend the work request. The Java process is not blocked by waiting for a response for a particular Job Identifier, the Java process may continue processing other work items requests or previously detected work item results.

Upon detection of a work item result, the Java process begins processing each work item result in the result buffer (304). The result buffer may host multiple work item results since multiple work items can be received concurrently and/or can be received while the Java process (or thread of the Java process) is in a wait state. A work item result being processed is referred to as a “selected result.” With tracking information (e.g., job identifier, session identifier, etc.) the Java process can determine a previously retrieved work item that corresponds to the selected result.

The Java process invokes native program code via a JNI to pass the selected result back into the non-Java address space (306). For example, the Java process invokes a Java method, Put, that the JNI translates or maps to native program code that include a native PUT method. Because the Java process cannot directly access low level resources like the common storage, the Java process leverages the native program code presented via the JNI to invoke the native program code to write the work item result to the common storage. The JNI includes program code that extracts the arguments from the Java Put method to conform to semantics of a native PUT method of the native program code mapped to the Java Put method. In addition, the JNI includes program code that transforms the selected result for compatibility with native formatting/encoding (307).

After transformation of the selected result, the invoked native program code updates the work item in common storage with the transformed, selected result (308). For instance, the native program code updates particular locations (e.g., fields) of the work item with the transformed, selected result. The layout of the work item may have been previously communicated with the work item. As another example, the selected result may comprise the work item already updated with the work item result by the Java process. Thus, updating the work item in common storage may be overwriting the work item in common storage with an already updated work item. In some cases, the work item will have specified a location for the work item result other than where the work item resides. The native program code can write a work item result to the specified location in common storage.

After placing the transformed, selected result into common storage, the native program code passes control of the work item (i.e., control of the area of common storage occupied by the work item) back to the originating process (i.e. the process that requested the corresponding work item from the non-Java address space) (310). The transfer control mechanisms and/or inter-process request mechanisms of the mainframe operating system create objects (e.g., transfer control blocks or service request blocks) or maintain data that indicate work requests waiting to be completed. For example, the native program code may also update the ECB to indicate that that the work item is complete. With the indication that the work item is complete in the ECB, control returns to the originating process. As another example, the native program code of the offload service may issue a TRANSFER command. After or while the native program code of the offload service provides the work item result, the Java process continues processing additional detected work item results, if any (312).

Variations

The above example illustrations presume that the offloading process is programmed to offload particular work items to the Java-based offload service. However, a mainframe service, for example a dispatch service, can evaluate work items and determine whether a work item should be directed to the Java-based offload service or directly to a particular resource accessible to the dispatch service.

In some embodiments, the communication between a non-Java address space and a Java address space is asynchronous instead of synchronous. In an asynchronous communication, an offloading process in the non-Java address space schedules (e.g. issues a MVS SCHEDULE or IEAMSCHD) a service request block (“SRB”) to native program code in the Java address space. The system dispatcher (e.g. MVS DISPATCHER) now has control of the work item to be offloaded and the work item task is inserted into the dispatcher queue (e.g. System Work Unit Queue (“SWUQ”), Alternate Work Unit Queues (“AWUQ”), etc.). When the SRB is dispatched, control passes to the native program code of the Java-based offload service. In another implementation, the dispatcher uses a different data structure in managing the ordering of the tasks. The system dispatcher may use a linked list for example.

Furthermore, the above example illustrations refer to transformations of work items and transformations of arguments between Java methods and native methods. One example refers to the native program code performing a transformation. The transformations can be performed either by the native program code or by Java program code. Transformations may be performed by both types of program code depending upon the direction of the transformation. For example, the native program code encapsulated within or referenced by the transforming interface can include native program code to perform transformations of work items being offloaded to the Java-based offload service. When a work item result is returned, Java program code of the transforming interface can transform the work item result.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. For instance, FIGS. 2 and 3 present example operations that traverse lists or queues of pending work items in common storage to offload with the Java-based offload service and work item results pending return from the Java-based offload service to the common storage. However, embodiments may process work items individually and avoid tracking in-flight work items. When the native program code passes a work item to the Java-based offload service, the native program code for work item retrieval completes execution. Although other processes in the mainframe environment can continue writing work items to be offloaded, the retrieval native program code underlying the Java-based offload service will not retrieve the next work item until the Java program code again invokes the retrieval native program code via the interface. For the work item result, the Java program code will invoke Java program code to put or return the work item result to the common storage, which will invoke via the interface the underlying native program code that puts the work item result back to common storage. After the invoked native program code puts the work item result in common storage, the native program code returns an indication to the Java program code that the work item result has been put back into common storage (i.e., the put of the work item result has completed). After receiving this indication, the Java program code again invoke the retrieval native program code via the interface to retrieve the next pending work item from common storage.

It should be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platform (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

Computer program code for carrying out operations for aspects of the disclosure may be written in any combination of one or more programming languages, including an object oriented programming language such as the Java® programming language, C++ or the like; a dynamic programming language such as Python; a scripting language such as Perl programming language or PowerShell script language; and conventional procedural programming languages, such as the “C” programming language or similar programming languages. The program code may execute entirely on a stand-alone machine, may execute in a distributed manner across multiple machines, and may execute on one machine while providing results and or accepting input on another machine.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

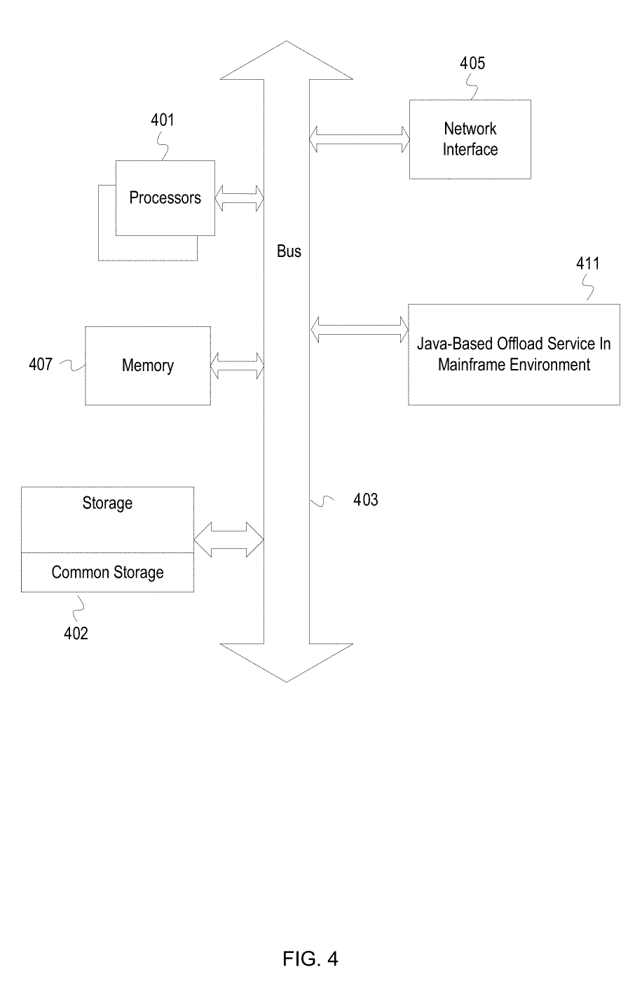

FIG. 4 depicts an example mainframe system with a Java-based offload service. The mainframe system includes processors 401 (e.g., multiple processors, multiple processors with multiple cores, etc.). The mainframe system includes memory 407. The memory 407 may be system memory (e.g., one or more of cache, SRAM, DRAM, zero capacitor RAM, Twin Transistor RAM, eDRAM, EDO RAM, DDR RAM, EEPROM, NRAM, RRAM, SONOS, PRAM, etc.) or any one or more of the above already described possible realizations of machine-readable media. The computer system also includes a bus 403 (e.g., Multibus bus, Unibus bus, VMEbus bus, etc.) and a network interface 405 (e.g., a Fiber Channel interface, an Ethernet interface, an interne small computer system interface, SONET interface, wireless interface, etc.). The system also includes a Java-based offload service 411 and storage 402, which includes common storage. The Java-based offload service 411 transfers work items from a non-Java address space on the mainframe to a Java address space for offloading to a resource that will process the work item. The Java-based offload service 411 returns work items results from its Java address space to a non-Java address space associated with the work item. Any one of the previously described functionalities may be partially (or entirely) implemented in hardware and/or on the processors 401. For example, the functionality may be implemented with an application specific integrated circuit, in logic implemented in one of the processors 401, in a co-processor on a peripheral device or card, etc. Further, realizations may include fewer or additional components not illustrated in FIG. 4 (e.g., video cards, audio cards, additional network interfaces, peripheral devices, etc.). The processors 401 and the network interface 405 are coupled to the bus 403. Although illustrated as being coupled to the bus 403, the memory 407 may be coupled to the processors 401 via a different interconnect(s).

While the aspects of the disclosure are described with reference to various implementations and exploitations, it will be understood that these aspects are illustrative and that the scope of the claims is not limited to them. In general, techniques for offloading work items with a Java-based offload service with cross address space transfers as described herein may be implemented with facilities consistent with any hardware system or hardware systems. Many variations, modifications, additions, and improvements are possible.

Plural instances may be provided for components, operations or structures described herein as a single instance. Finally, boundaries between various components, operations and data stores are somewhat arbitrary, and particular operations are illustrated in the context of specific illustrative configurations. Other allocations of functionality are envisioned and may fall within the scope of the disclosure. In general, structures and functionality presented as separate components in the example configurations may be implemented as a combined structure or component. Similarly, structures and functionality presented as a single component may be implemented as separate components. These and other variations, modifications, additions, and improvements may fall within the scope of the disclosure.

This description refers to “native program code” and “native code.” These terms refer to machine code that is native to the hosting platform, in this case a mainframe. The term “native program language” refers to a program language (e.g., assembler) that compiles into a platform dependent machine code, and not an interpreted language.

What is claimed is:

1. A method comprising:
detecting, by an invoked first native program code previously invoked via an interface between the first native program code and a first process executing in a Java virtual machine, a computing task in common storage of a mainframe environment, wherein the computing task is associated with a first address space;
retrieving, by the invoked first native program code, the computing task from the common storage into a second address space of the mainframe environment, wherein the Java virtual machine executes within the second address space;
passing the computing task from the invoked first native program code to the first process via a buffer of the Java virtual machine;
communicating, by the first process, the computing task to a resource that will process the computing task;
in response to receipt of a result for the computing task, the first process invoking a second native program code via the interface to return the result to the first address space associated with the computing task; and
in response to invocation of the second native program code, the invoked second native program code writing the result to the common storage.

2. The method of claim 1 further comprising the invoked second native program code notifying a native process in the first address space of the result.

3. The method of claim 1, wherein writing the result to the common storage comprises updating the computing task in the common storage with the result.

4. The method of claim 1, wherein passing the computing task comprises:
the invoked first native program code copying the computing task into a region of the second address space; and
the invoked first native program code invoking, via the interface, a Java method that indicates insertion of an item into the buffer, wherein the buffer corresponds to the region of the second address space.

5. The method of claim 1, wherein the buffer is a Java char buffer.

6. The method of claim 1, wherein the interface is a Java Native Interface.

7. The method of claim 1 further comprising:
invoking a third native program code, by the first process via the interface, to establish an anchor in the common storage for computing tasks to be offloaded through the Java virtual machine; and
the invoked third native program code creating a storage anchor block in the common storage and creating a control block to be updated when a computing task is written to the anchor.

8. The method of claim 1, wherein passing the computing task comprises:
transforming the computing task to be compatible with the first process.

9. The method of claim 1 further comprising transforming the result to be compatible with the mainframe environment prior to the invoked second native program code writing the result to the common storage.

10. The method of claim 1, wherein the first and second native program codes and the interface are within the second address space.

11. The method of claim 1, wherein the interface comprises mappings between Java methods of the first process and the native program codes.

12. One or more non-transitory machine readable media comprising program code for a Java-based offload service in a mainframe environment, the program code comprising:
a first native program code to,
detect a computing task written to a region of mainframe common storage allocated for computing tasks to be offloaded via a Java virtual machine, and
retrieve the computing task into a first address space that is in the mainframe environment and that is associated with the Java virtual machine;
a second native program code to,
return a result of a computing task from the first address space to the region of the mainframe common storage; and
Java program code to,
invoke the first native program code via a native interface to retrieve a computing task pending in the region of the mainframe common storage;
offload a computing task provided by an invocation of the first native program code to a resource for processing; and
invoke the second native program code via the native interface in response to receipt of a result for an offloaded computing task.

13. The one or more non-transitory machine readable media of claim 12 further comprising native interface code to map methods of the Java program code to methods of the first and second native program codes.

14. The one or more non-transitory machine readable media of claim 12 further comprising a third native program code to establish a queue in the mainframe common storage for the computing tasks to be offloaded by the Java program code.

15. A mainframe comprising:
a plurality of processors;
common storage; and
a machine readable medium comprising,
a first native program code to executable by at least one of the plurality of processors to cause the mainframe to,
detect a computing task written to a region of the common storage allocated for computing tasks to be offloaded via a Java virtual machine,
retrieve the computing task into a first address space of the mainframe and that is associated with the Java virtual machine;
a second native program code executable by at least one of the plurality of processors to cause the mainframe to,
return a result of a computing task from the first address space to the region of the common storage;
Java program code executable within the Java virtual machine to cause the mainframe to,
invoke the first native program code via a native interface to retrieve a computing task pending in the region of the common storage;
offload a computing task provided by an invocation of the first native program code to a resource for processing; and
invoke the second native program code via the native interface in response to receipt of a result for an offloaded computing task.

16. The mainframe of claim 15, wherein the machine readable medium further comprises program code of the native interface code to map methods of the Java program code to methods of the first and second native program codes.

17. The mainframe of claim 16, wherein the program code of the native interface comprises program code to transform computing tasks from being compatible with an environment of the mainframe to being compatible with the Java virtual machine and to transform results of offloaded computing tasks from being compatible with the Java virtual machine to being compatible with the environment of the mainframe.

18. The mainframe of claim 15, wherein the machine readable medium further comprises a third native program code to establish an anchor in the common storage for the computing tasks to be offloaded by the Java program code.

19. The mainframe of claim 15, wherein the Java program code to offload the computing task comprises the Java program code to communicate the computing task to a resource external to the mainframe or to a specialized resource of the mainframe.

20. The mainframe of claim 15, wherein the native interface complies with the Java Native Interface.
